(19) United States
(12) Patent Application Publication
(10) Pub. No.: US 2007/0211826 A1
(43) Pub. Date: Sep. 13, 2007

(54) Method and Device for Wireless Data Transmission

(76) Inventors: Ralf Otte, Weinhelm (DE); Hartmut Muller, Munchen (DE); Martin Nathansen, Munchen (DE)

Correspondence Address: Francis C Hand;Carella Byrne Bain Gilfillan Cecchi Stewart &, Olstein, 5 Becker Farm, Roseland, NJ, 07068, US

(21) Appl. No.: 10/586,756

(22) PCT Filed: Feb. 2, 2005
(86) PCT No.: PCT/CH05/00057

§ 371 Date: Oct. 26, 2006

(30) Foreign Application Priority Data
Feb. 19, 2004 (DE) 10 2004 008 444.0

(51) Int. Cl. H04B 13/00

(52) U.S. Cl. 375/308

(57) ABSTRACT

The invention relates to a method for transmitting data, whereby all necessary information is transmitted on the basis of a global scaling modulation and demodulation by random processes, by carrying out a modulation, coupling or decoupling and demodulation of resonating frequency-coupled noise processes.

The present invention relates to a method and a device for wireless transmission of data. The method is suitable for transmitting digital data. The present invention is applicable in many fields of information transmission, for example, in telecommunications, measuring technology, sensors, and medical technology.

Using deterministic methods based on progressive electromagnetic carrier waves is typical for wireless signal and data transmission. This means that a transmitter emits the modulated signal directly, or typically using a carrier wave. The useful information is modulated on the carrier wave using different modulation methods, such as amplitude, frequency, or phase modulation.

Furthermore, it is known how the technical transmitting and receiving devices must be constructed to perform the modulation and demodulation, transmission and reception.

A dependence of the power consumption of the transmitter on the distance to be covered and the necessity of relay stations when transmitting over large distances results from the known technical transmission methods and their physical properties.

The present invention is based on the object of specifying a method for wireless data transmission which combines the lowest possible power consumption at the transmitter and receiver with the highest possible range of the information transmission.

This object is achieved by a method specified in Claim 1 and a device specified in Claim 6 for global scaling communication, or GSCOM in short, in which data transmission over large distances is implemented using global scaling (GS) modulation and demodulation of coupled random processes.

Advantageous embodiments are specified in further claims.

GS is an introduced physical concept which illustrates that frequency distributions of physical variables such as masses, temperatures, weights, and frequencies of real systems are logarithmically scale-invariant, see H. Müller, Global Scaling, Special 1, Ehlers Verlag 2001.

With the aid of GS, in particular those physical values which are preferably included in real processes, particularly random processes, may thus be calculated.

These preferred values may be ascertained by a continued fraction decomposition according to Leonard Euler, Über Kettenbrüche [on continued fractions], 1737, Leonard Euler, Über Schwingungen einer Seite [on oscillations of a side], 1748, because it is known according to Euler that every real number x may be represented by its continued fraction corresponding to equation (1):
x=n₀+z/(n₁+z/(n₂+z/(n₃+z/(n₄+z/(n₅+ . . . ))))) (1)

The variable z represents the partial numerator in this case, whose value is fixed at the value 2 according to GS for subsequent frequency analyses.

Since the scale invariance occurs at logarithmic scales, in the GS method, all analyses are performed of variables whose base e logarithm has been taken. Equation (2) thus results
ln x=n₀+2/(n₁+2/(n₂+2/(n₃+2/(n₄+2/(n₅+ . . . ))))) (2).

The particular numeric values are a function of the mass units used as the basis. In GS, the variables to be analyzed are set in relation to physical constants y, the standard measures. These constants are only known within a predefined precision, however, because of which there are upper and lower limiting values for these constants.

Equation (3) thus results as the most important basic equation of GS, which may be expanded through a phase shift by φ=3/2, which is not relevant for the explanations of the present invention, however, see H. Müller, Global Scaling, Special 1, Ehlers Verlag 2001:
ln(x/y)=n₀+2/(n₁+2/(n₂+2/(n₃+2/(n₄+2/(n₅+ . . . ))))) (3)

The integral partial denominators [n₀,n₁,n₂ . . . ] must always have an absolute value greater than the numerator because of the convergence condition for continued fractions, see O. Perron, Die Lehre von den Kettenbrüchen [the teaching of continued fractions], Teubner Verlag, Leipzig, 1950, and are always whole numbers divisible by 3.

Through application of equation (3), a predefined physical variable, such as a frequency, may be decomposed according to the GS continued fraction method and converted into a continued fraction code. This is to be described for exemplary purposes by a GS continued fraction decomposition for a frequency f₀.

In GS, the value 1.4254869e24 Hz is used as the physical constant y for calculating frequencies, see the section standard measures in H. Müller, Global Scaling, Special 1, Ehlers Verlag 2001.

According to equation (3), a continued fraction decomposition and the calculation of the partial denominators n₀, n₁, n₂, n₃, n₄, etc., results. The calculation of the frequency values by continued fractions according to equation (3) was performed for exemplary purposes using the tool GSC3000 professional of the Institutes für Raum-Energie-Forschung GmbH, Wolfratshausen and is shown as an example in FIG. 1 for the frequency f₀=2032 Hz. The frequency 2032 Hz corresponds to the GS continued fraction code [−48; 9086]. The partial denominator n₀=−48, the partial denominator n₁=9086 or n₁=9036, depending on the limiting value of the constant y used for the frequency.

Since the partial denominator no in this example (n₁=9086) is large and thus the overall quotient beyond n₁ is vanishingly small, the frequency 2032 Hz is close to the value n₀ (n₀=−48) and is thus also referred to as the GS node point. Further GS node point frequencies according to equation (3) are, for example, 5 Hz, 101 Hz, 40804 Hz, 16461 kHz. The present invention will be described further base on these foundations of GS frequency analysis.

It is an object to specify a method and a device, which permit significant reduction of the transmission power in order to transmit data over the greatest possible distances and using the least possible energy.

Furthermore, a modulator and/or demodulator and a modulation method and/or demodulation method, which allows cost-effective modulation and/or demodulation, are specified. In the following, the modulator is identified as a GS modulator and the demodulator is identified as a GS demodulator, since the modulation and demodulation are implemented based on GS.

An additional object of the present invention is increasing the range and the security of information transmission.

While in typical methods the transmission is performed through the manipulation of deterministic processes, in the method according to the present invention, the transmission is performed through GS modulation and GS demodulation of coupled random processes.

A device for wireless information transmission, e.g., of data or signals, comprises a transmission unit having a modulator for global scaling modulation of information and having a coupler for coupling the information into a random process, a receiver unit having a demodulator for global scaling demodulation of information and a decoupler for decoupling the information from the random process.

The device and the method use coupled random processes, in particular coupled noise processes, as information carriers.

FIG. 10 shows the mean fluctuation of unfiltered binary numbers over the natural-logarithmic time axis for a period of time of 12 hours. The data was obtained using hardware according to the variation described in chapter 1.2 and using software according to equation (5).

In addition, software-based subsampling of the raw data provided by the sound card was implemented in order to obtain a GS-conformal node point frequency f₀. The typical periodic fluctuations expected according to global scaling are visible over the natural-logarithmic time axis.

There are manifold possibilities for implementing and/or refining the method according to the present invention, the device, and the assemblies and/or units in preferable ways. For this purpose, reference is made to both the subordinate claims and also to the description and the exemplary embodiment. In the drawing:

FIG. 1: shows tool GSC3000 for GS analysis of frequencies

FIG. 2: device and method schematics of data transmission

FIG. 3: shows detailed schematics of the method and the device

FIG. 4: shows background noise of a semiconductor component

FIG. 5: shows harmonic components of the background noise

FIG. 6: shows a circuit diagram of an external noise generator for technical generation of white noise

FIG. 7: shows variant a having an external noise module

FIG. 8: shows an external noise module for variant a

FIG. 9: shows variant c having an external modem

FIG. 10: shows fluctuation of binary numbers over the natural-logarithmic time axis

FIG. 11: shows an illustration of a noise spectrum of a bipolar transistor (BE section)

According to S. Shnoll, coupling effects of random processes of different strengths occur when these are performed simultaneously and synchronously (Shnoll S. E. et al., Realization of discrete states during fluctuations in macroscopic processes, Physics-Uspekhi, 41(10), page 1026, 1998), i.e., during simultaneously performed measurements on random processes, the frequency distributions of the physical measured values have identical fine structures. The pattern of the (non-smoothed) histograms of the measured values of multiple simultaneously performed random processes correspond or are similar. The representation of non-smoothed histograms is also referred to in global scaling as the fine structure of the histogram.

A high degree of correspondence of the fine structure is recognized when the histograms of the random processes used as the basis are very similar even in their smaller instances, i.e., not only their statistical characteristics such as mean values, variances, etc., correspond, but rather also the frequencies of specific measured values in the particular histograms very frequently correspond. However, this correspondence is analyzed according to GS only in non-smoothed histograms.

The identity and/or similarity of the fine structure of histograms is now defined as the degree of the actual synchronicity of random processes. In the following, random processes having a high degree of correspondence in the fine structure of the histograms are referred to as coupled random processes.

For the transmission of data from a transmitter S (transmitting unit 1) to a receiver E (receiving unit 2), random processes, which are coupled to one another through suitable measures, are generated in both technical terminals S and E.

Transmitter and receiver are implemented in this method through technical terminals which firstly contain a technical noise source or permit connection of a technical noise source and secondly may perform the following processing steps 1-8 in real time.

The sequence of the method is schematically shown in FIG. 2, transmitting and receiving units are described in more detail in FIG. 3.

The device contains a list according to FIGS. 2 and 3.

A commercially-available computer, such as a laptop having an integrated sound card, is used in each case for the transmitter device (3, 4, 6, 7) and the receiver device (8 through 11). I.e., in the following, the generation (3, 4), modulation (6), coupling (7), decoupling (8), and demodulation (9) of coupled random processes in a transmission link for coupled random processes (5) is shown based on the noise processes of the sound cards of two commercially available computers (transmitting unit 1 and receiving unit 2).

However, the method is applicable for any technically generated random process which may be manipulated, e.g., based on external or internal noise generators, semiconductor components, processors, modems, etc.

The terminals are commercially available computers, laptops, or even mobile telephones. However, the method is also applicable for other terminals, other sampling frequencies f₀, other random processes, or other changes, also of other continued fraction code components, in the following example only n₂.

1. Coupling to a Noise Process (Information 3 and Input Signal 4)

A transmitter and a receiver are tuned to a joint frequency band (e.g., from 5 Hz to 16.4 MHz) of a technical noise process.

To generate the noise process, the sound card of a commercially available computer or laptop may be used, for example. The frequency band of the noise is thus, for example, between 100 Hz and 15 kHz. Further technical noise sources would be semiconductor elements or computer processes, for example. The time curve of a typical noise signal of a technical noise source is shown in FIG. 4.

The noise signals of the sound card are accessed using software, for example, using Windows commands, and the particular noise level is provided to downstream analysis software.

1.1. Selection of a Stochastic Process Which is Influenced by the Background Wave

The standing background waves influence all local wave, oscillation, and random processes, however, this is particularly visible and measurable if the local oscillation process oscillates in proximity to a natural oscillation of higher priority (this will be explained in the following section). The local process then comes into resonance with the background field, which may be empirically proven in that it no longer behaves statistically correctly, but rather prefers certain value instances and avoids others.

Local oscillation processes which may be influenced very well by the background waves are all random processes, such as radioactive decomposition processes, noise processes, or weather processes.

1.1.1. Selection of the Stochastic Process

Especially good technical coupling of a local oscillation process to the background wave is achieved via stochastic or white noise in the transmission channel. This noise is characterized in that it is not deterministic and is not reproducible.

Suitable sources are technical noise processes, thermal noise, or shot noise. Thermal noise occurs in every electronic component subject to resistance and is caused by random velocity variations of the freely movable electrons and electron holes. As a function of the type of the component and the temperature, this noise is only a few μV and requires strong electronic amplification. Significantly stronger noise signals are provided by pn transitions of semiconductor components, either of Z diodes or of incorrectly polarized base emitter sections of bipolar silicon transistors. The noise is generated here at a pn boundary layer which is operated above the breakthrough voltage. The charge carriers break through the barrier layer because of the applied voltage and generate the shot noise (Verges, C. 1987, Handbook of Electrical Noise, TAB Books, Blue Ridge Summit, Pa.).

The height of the achievable noise level is strongly dependent in this case on the height of the breakthrough voltage and the size of the flowing current. Using selected Z diodes and breakthrough voltages of >20V, noise levels of >1 Vpp and linear noise spectra up into the MHz range may be achieved. However, even smaller breakthrough voltages of 7-12 V and currents of 10-200 μA generate noise levels of a few hundred mVpp on BE sections of selected bipolar transistors (see FIG. 11), so that additional amplification is often superfluous. Since the noise level grows proportionally to the square root of the current flowing at constant load, it may additionally be regulated within wide limits.

1.1.2. Technical Implementation of the Coupling to the Background Wave

In the following, three methods for coupling to the background wave are described. Variant a requires an additional external module for generating technical noise in addition to the laptop. Variant b uses the noise generator implemented in the Pentium III processor and requires no additional hardware. Variant c implements all functions for coupling to the background wave in an external modem.

Variant a: coupling to the background wave using external noise generator

FIG. 6 shows a circuit diagram of an external noise generator for generating the white noise and FIG. 7 shows the construction, comprising the external module having the analog noise generator and the laptop having integrated sound cards 21 for analog/digital conversion 22 of the noise signal provided by the analog noise generator 20 and the computer system for digital filtering and the processing software.

The analog noise generator 20 provides a pink to white noise signal, which is generated as described under 1.1.1. Noise signals which have a level drop of 3 dB per octave with rising frequency are referred to as pink. White noise signals, in contrast, display an approximately linear frequency response. Transistor T1 generates the noise signal on its base emitter section, which is operated above the breakthrough voltage. Transistor T2 is used as an impedance converter and amplifier and converts the noise current from T1 into a noise voltage. The noise voltage is capacitively decoupled from T2 at the collector and fed via a single-stage high-pass filter into the input of the sound card.

The input-side channel of the sound cards comprises an amplifier, a band pass filter for frequencies from 100 Hz to 15 kHz, a 14-bit analog/digital converter and the interface to the PCI bus of the laptop. The sound card samples the low-frequency noise at a clock rate of 44.1 kHz, converts it into 14-bit width signed integer numbers and provides these via the driver software to the processing software. FIG. 8 shows the implementation of the noise generator 20, which is connected to the laptop 21.

The processing software filters the numbers thus obtained and extracts the actual useful signal.

Variant b: coupling to the background wave using internal noise generator

Variant b uses the internal random generator provided in the Pentium III as a noise source (The Intel® Random Generator, Techbrief 1999, Intel®). The additional external module from variant a is thus dispensed with.

The processing software in variant b contains a driver function for the internal random generator instead of the driver function for activating and reading out the sound card. The further software-side processing of the noise signal is identical to variant a.

Variant b has the disadvantage of restriction to computer systems having Pentium III or Pentium 4 processors.

Variant c: coupling to the background wave using external modem

In variant c shown in FIG. 9, all essential functions for coupling to the background wave are implemented in an external modem 30. This modem 30 is connected to the laptop 31 via a USB interface.

The modem 30 contains a broadband analog noise source (noise generator 32), an impedance converter 33, a filter and amplifier 34, an analog/digital converter 35, and an interface component (controller 36) for the USB bus. In addition, the modem 30 may contain a microcontroller for digital filtering and preprocessing of the useful signal. These functions may, however, as in variants a and b, be assumed by the processing software on the laptop. The processing of the noise signal and useful signal is performed analogously to variants a and b. Significantly higher data rates are achievable than in variants a and b.

1.1.3. Software Algorithms for Preprocessing and Filtering of the Background Wave

The preprocessing and filtering of the data obtained by the method described in chapter 1.1.2 is performed through processing software installed on the laptop. This software contains, in addition to filters for the typical equalization, a special adaptive global scaling filter which temporarily stores the raw data obtained over a sufficiently long period of time and analyzes it in the time and value range according to the typical global scaling patterns. The analysis of the GS patterns is either performed on the basis of histograms over the entire value range of the raw data or on the basis of time in regard to the logarithmic-hyperbolic fluctuations of the individual data in the time range.

The object of the software is to generate random numbers from the technical noise signals, electrical potentials, etc., which may be processed further later. A possible computing operation for the generation of random numbers ZZ from the noise signal is the sampling of the noise signal using a node point frequency f_{A} and subsequent conversion of the noise level into a numeric value ZZ according to equation (5), for example
ZZ [0 . . . n−1]=moduloₙ (Σ(normalized noise level of the noise signal)) (5).

Random numbers which are generated in this way are manipulated by the background wave, which may be determined empirically in that they do not behave statistically correctly when the sampling frequency f_{A} is in proximity to a node point frequency. Thus, a number n does not occur arbitrarily randomly but rather at a logarithmic hyperbolic interval, similarly as it is calculated according to global scaling.

Instead of generating analog random numbers, it is also possible to generate binary numbers and evaluate the density of the occurring ones or zeros as fluctuations, as deviations from the expected value 0.5. For example, if the number one occurs six times in series, this indicates a greater fluctuation than when a one appears three times, etc.

Binary random numbers may be generated by replacing “n” from equation (5) with the number two:
ZZ [0 . . . n−1]=modulo₂ (Σ(normalized noise level of the noise signal)) (5).

A further method is the calculation of binary numbers from the slope of the noise signal in the sampling points. A positive slope results in a one and a uniform or negative slope results in a zero. In addition, the binary random numbers thus obtained may be linked to a progressive zero-one sequence logically via an exclusive-or function (EXOR), in order to obtain the best possible equipartition of zero and one.

FIG. 10 shows the mean fluctuation of unfiltered binary numbers over the natural-logarithmic time axis for a period of time of 12 hours. The data was obtained using hardware according to described variant a and using software according to equation (5).

In addition, software-base subsampling of the raw data provided by the sound card was implemented in order to obtain a GS-conformal node point frequency of 5 Hz.

In order to make a fluctuations on the logarithmic time axis more clearly visible, the data was additionally filtered using statistical software. For this purpose, the data was first differentiated by calculating the differential quotients. Subsequently, the differential quotients were added up in periods of time of 10 seconds and integrated using a sliding low pass function over 300 time periods.

The typical periodic fluctuations expected according to global scaling are shown over the natural-logarithmic time axis in FIG. 5. 7½ oscillations having constant period time and rising amplitude are shown. The maxima of the oscillation antinodes are at approximately −3.6:1.6 minutes, −2.7:4.0 minutes, −1.8:9.9 minutes, −0.9:24.4 minutes, 0.0:1.0 hours, 0.9:2.45 hours, 1.8:60 hours, (2.7:14.8 hours approximately). These oscillation antinodes identify the areas having the greatest fluctuations and are in the global scaling node points.

2. Sampling of the Noise Processed to Generate Random Numbers (Input Signal 4)

In order to further process the noise process, random numbers are generated through sampling of the noise signal. The sampling of the noise processes in the transmitter and receiver is performed according to the present invention using a GS node point frequency f₀ and thus results in the generation of a GS time sequence of random numbers Z.

A suitable node point frequency for the sampling of noise signals of the sound card is, for example, f₀=2031.55 Hz. Other node point frequencies may be ascertained using equation (3).

The GS sampling signal is then converted into a normalized, dimensionless sequence of numeric values (Z), possibly of the value range N, for example, through residual class formation R modulo N (modulo operator) according to the formula Z≡Z modulo N, N being a whole number.

The random number sequence Z_{S} thus arises at the transmitter S and the random number sequence Z_{E} arises at the receiver E. For example, the following sequence of random numbers has resulted through the sampling and is displayed on the monitors of the transmitter and receiver:
Z_{S}={ . . . 10 23 2500 249 28 378 40456 . . . }
Z_{E}={ . . . 45 789 4581 45 3 6782 2360 . . . }

The two random number sequences Z_{S} and Z_{E} at the transmitter and receiver, respectively, are typically not chronologically synchronous without technical measures, however.

In order to achieve synchronicity and thus coupling of both random processes, chronological synchronicity of both processes in the transmitter and receiver must be produced—as described in Shnoll. Therefore, the noise processes are sampled chronologically synchronously at the transmitter and receiver, i.e., always at identical instants.

The random numbers at the transmitter and receiver thus arise chronologically synchronously. Technically, the synchronous sampling may be implemented by the controller via an external radio clock on both terminals, for example. The precision of the synchronous clock is to be at least one order of magnitude more precise than the sampling frequency.

The periods Δtₛ=1/f₀=tᵢ₊₁−tᵢ thus result at the transmitter and receiver in synchronous cycle, for example, the following random numbers which may also be shown using software on the computer display screen:
Z_{S}={ . . . 11(tᵢ₊₀)80(tᵢ₊₁)3421(tᵢ₊₂)345(tᵢ₊₃)245(tᵢ₊₄)4512(tᵢ₊₅)5071(tᵢ₊₆) . . . }
Z_{E}={ . . . 2345(tᵢ₊₀)479(tᵢ₊₁)23(tᵢ₊₂)346(tᵢ₊₃)11(tᵢ₊₄)6593(tᵢ₊₅)5031(t₁₊₆) . . . }

The present invention will be described further in the following method steps 3-8, these steps having to be implemented within the sampling periods Δtₛ according to the present invention.

For example, if the last random numbers from the noise were each ascertained at the identical instant tₙ₋₁ at the transmitter and receiver, the processing steps must be performed on the transmitter side even before the current random number is ascertained from the noise Z_{E}(tₙ) at the receiver at instant tₙ.

The following equation thus applies:
tₙ=tₙ₋₁+Δtₛ

For the above-mentioned sampling frequency f₀ of 2031.55 Hz, the sampling period Δtₛ=1/f₀=4.92e−4 seconds in the example, within which the processing steps must be performed. This is possible using commercially available computers.

3. Derivation of the Random Number Sequence (Information 3, Input Signal 4)

Proceeding further, in the transmitter and somewhat time-delayed in the receiver according to L. Euler (A. P. Jushkewitsch. Euler und Lagrange über die Grundlagen der Analysis [Euler and Lagrange on the Foundations of Analysis]. In: K. Schröder: Sammelband der zu Ehren des 250. Geburtstages Leonhard Eulers der Deutschen Akademie der Wissenschaften zu Berlin vorgelegten Abhandlungen. Berlin 1959), derivation of the GS time sequence of random numbers Z_{S} and Z_{E} of the form f′(x)=lim((f(x+dx)−f(x))/dx) with dx→0 is implemented.

For non-analytic functions, as represented by random number sequences Z_{S} and Z_{E}, however, dx=1 is set according to Euler, equation (4) thus resulting.
f′(x)=lim((f(x+dx)−f(x))/dx) with dx=1 (4)

A new random sequence f_{S}{ } or f_{E}{ } of alteration speeds of the random numbers from Z_{S} or Z_{E}, respectively, thus results at the transmitter and receiver. These alteration speeds of random numbers may also be interpreted as a frequency f, the sampling period Δtₛ for generating Z_{S} or Z_{E} determining the chronological scale.

FIG. 5 represents a possible result f_{S}{ } of the derivation of the signal Z_{S} from a noise process according to FIG. 4.

For example, the following series of alteration speeds and/or frequencies arises within a predefined frequency band of [n₀, n₁−1] through [n₀, n₁+1] through derivation according to equation (4) of the sequence Z_{S} at the transmitter:
f_{S}{ }={ . . . 1883.93(tₖ₊₀)1885.15(tₖ₊₁)1889.87(tₖ₊₂)1885.51(tₖ₊₃) . . . }

A similar sequence of frequency values f_{E}{ } is calculated for the receiver within the same predefined frequency band.

4. Search for GS Frequencies (Information 3, Input Signal 4)

A global scaling frequency which may be represented by a GS continued fraction code of the structure [n₀, n₁, n₂].

For this purpose, for each ascertained frequency from the sequence f_{S}{ } at the transmitter according to equation (3), a continued fraction analysis is performed and the associated partial denominators n₀, n₁, n₂, etc., are determined.

For example, within the predefined frequency band from [−48, −26] through [−28], i.e., from 1881.13 Hz (continued fraction code: [−48, −26]) through 1891.50 Hz (continued fraction code: [−48, −28]) in the sequence f_{S}{ }, the frequency f_{R}=1889.87 Hz is ascertained, for which a continued fraction code of the structure [n₀, n₁, n₂] exists.

The continued fraction code for f_{R}=1889.87 is equal to [−48, −27, −3].

The partial denominator n₂ is −3 in this example.

According to GS, the same frequency f_{R} is found in this case within the frequency band at the transmitter and receiver, i.e., both original random number sequences Z_{S} and Z_{E} have precisely a shared GS alteration speed of their random numbers in the predefined frequency band.

This is referred to in the following as the resonance frequency f_{R} of both random number sequences Z_{S} and Z_{E}.

5. GS Modulation on Transmitter Side (GS Modulator 6)

At the transmitter, the GS modulation is performed, for example, through an alteration of the partial denominator n₂, for example, by a sign change of n₂. The following new continued fraction code [n₀, n₁, −n₂] thus results on the transmitter side and a new frequency f_{R}′ results through reversal of equation (3).

In the example, the GS continued fraction [−48, −27, −3] belonging to f_{R}=1889.87 Hz is changed to [−48, −27, +3], i.e., the partial denominator n₂=−3 is set to n′₂=+3 by changing the sign. The new frequency f_{R}′=1882.97 Hz results therefrom after reverse application of equation (3).

This frequency f_{R}′ also mathematically represents an alteration speed of the random numbers and a new random number Z′_{S}(tₙ) is calculated in the transmitter based thereon through the reversal of the derivation according to L. Euler from equation (4), which is coupled into the noise process in the following at the transmitter at instant t₀.

Since all method steps were performed within the sampling period Δtₛ, the manipulated random number Z′_{S}(tₙ) was calculated on the transmitter side even before a new random number was generated at the transmitter or receiver via the noise process.

The reversal of equation (4) is possible since the derivation of equation (4) represents a unique deterministic method. For the same reason, equation (3) is also reversible.

In the example, the new random number Z′_{S}(tₙ)=192 has resulted and the following series of random numbers results at instant tₙ:
Z_{S}={ . . . 11(tᵢ₊₀)80(tᵢ₊₁)3421(tᵢ₊₂)345(tᵢ₊₃)245(tᵢ₊₄)4512(tᵢ₊₅)50712(tᵢ₊₆) . . . 192(tₙ)}

6. Coupling and/or Physical Generation of the Newly Calculated Noise Values (Coupler 7)

The newly calculated random number Z′_{S}(tₙ) is converted into a noise level value having a dimension and coupled into the random process within the sampling period. This conversion is possible since the method of the conversion of the noise level value into random numbers is known and reversible from the preceding method steps.

In the example of the production of the random numbers using the noise of a sound card, the new random number (Z′_{S}(tₙ)=192) is thus converted on the transmitter side into noise value and physically output via the sound card.

The noise on the transmitter side is thus modulated through this coupling of the noise level value belonging to Z′_{S}(tₙ).

7. Decoupling and/or Demodulation on Receiver Side (Decoupler 8 and/or GS Demodulator 9)

Since the random processes of the transmitter and receiver were synchronized by the GS node point frequency and are coupled to one another by chronological synchronicity, and very definitely have identical resonance frequencies and/or alteration speeds, the noise process on the receiver side has also changed temporarily.

The noise signal in the receiver is decoupled at instant tₙ by sampling using f₀ and converted into random numbers according to the same method as on the transmitter side.

The random number fed into the transmitter (in the example Z′_{E}(tₙ)=192, but in any case a random number Z′_{E}(tₙ) which causes the defined resonance frequency f_{R}′ at the receiver in the later derivation of the sequence Z_{E} according to L. Euler (equation (4)) appears with high probability on the receiver side at sampling instant tₙ.

In the following, it is described how this resonance frequency f_{R}′ manipulated on the transmitter side is found and decoded on the receiver side.

According to the present invention, the receiver analyzes the frequency band previously tuned with the transmitter from [n₀, n₁−1] through [n₀, n₁+1] and, based on the newly ascertained random number Z′_{E}(tₙ), all existing frequencies within the frequency band through a GS analysis and determines the unique frequency f′_{R} for which the continued fraction code [n₀, n₁−n₂] exists.

The partial denominator n₂ is determined for this frequency f′_{R}.

For example, based on the last received random number within the frequency band, agreed on with the transmitter, from 1881.13 Hz (continued fraction code: [−48, −26]) through 1891.50 Hz (continued fraction code: [−28]) of the sequence f_{E}{ }, the shared frequency f′_{R}=1882.969 Hz is found, for which a continued fraction code of the structure [n₀, n₁, n₂] exists. The continued fraction code for f′_{R}=1882.969 Hz is equal to [−48, −26, +3]. The partial denominator n₂ is thus +3.

8. Decoding the Transmitted Information (Information 10, Output Signal 11)

Through comparison of the ascertained continued fraction code with the code determined according to GS, the receiver may now recognize whether the n₂ value was manipulated on the transmitter side.

For example, according to GS, the expected sign of n₂ may be determined using a computer solely from the combination of sampling periods Δtₛ, n₀, and n₁, because the frequency band is uniquely fixed by n₀ and n₁ in that the expected global scaling resonance frequency f_{R} of the random process must be present.

In the example of Δtₛ=4.92e−4 seconds, n₀=−48 and n₁=−27, a frequency f_{R} having the associated continued fraction code [−48, −27, −n₂] is expected on the receiver side, which also applies for the non-modulated case in the transmitter on the receiver side.

In the example of the modulation shown, the analysis in the receiver of all frequencies within the frequency band agreed on with the transmitter only resulted in the frequency f′_{R}=1882.969 Hz, however, for which a continued fraction code of the structure [n₀, n₁, n₂] exists. The continued fraction code for f′_{R}=1882.969 Hz is [−48, −26, +3].

The partial denominator n₂ is thus +3.

However, since a n₂ value of −3 was expected on the receiver side, the receiver has recognized that the n₂ value of the resonance frequency f_{R} was modulated on the transmitter side.

The receiver thus recognizes the manipulation on the transmitter side when it is present.

Therefore, a bit of information has been transmitted between transmitter and receiver via the basic, coupled noise process through GS modulation and GS demodulation of a joint resonance frequency f_{R}. Through the possibility of the transmission of a bit, digital signals are thus transmittable in principle.

The technical transmission rate via the random process described here is determined and limited by the execution speed of steps 1 through 8 and by the sampling frequency f₀. Therefore, transmission rates of 16 bits per second are thus currently implemented.

An increase of the transmission rate is possible, for example, through the use of other sampling frequencies f₀, faster computers, improved GS modulation of the continued fraction value n₂ (and/or higher elements of the continued fraction n₃, n₄, etc.) instead of only one sign reversal or the parallel use of multiple transmission channels.

Through analog/digital conversion before the actual GS transmission and subsequent GS modulation, arbitrary signals and information, such as speech, are additionally transmittable.

1. A transmission [sic; method] for wireless transmission of data or signals using a transmitting unit having a modulator for modulation of the information and having a coupler for coupling the information into a random process, a receiving unit having a demodulator for demodulation of the information and a decoupler for decoupling the information from the random process, characterized in that the data transmission is performed via and/or using coupled random processes.

2. The method according to claim 1, characterized in that the global scaling modulator and a global scaling demodulator are used as the modulator and demodulator, respectively.

3. The method according to claim 1, characterized in that a noise or random signal of a noise or random signal generation element or process is used as the signal or signal generation element for the coupler and decoupler and/or the modulator/demodulator, preferably technical noise or random signals or processes such as thermal or white noise or noise or random signal elements such as a noise diode.

4. The method according to claim 1, characterized in that at least one element of the continued fraction code [n0, n1, n2, n3, . . . ] of the resonance frequency fR is modulated, for example, through sign reversal.

5. The method according to one of the preceding claims, characterized in that it comprises the following method steps:
generating a noise signal in the transmitting and receiving unit (S, E, 1, 2), preferably an electrical noise signal
sampling the noise signal using a GS node point frequency ta, preferably a n0 frequency to generate a sampling signal,
converting the GS sampling signal into a normalized, dimensionless sampling signal in the form of numeric values (Z), preferably through residual class formation R modulo N (modulo operator) according to the formula Z=Z mod G, G being a whole number and being able to represent the measured noise level,
deriving the numeric sequences ZS and ZE according to L. Euler to prepare a sequence of frequencies fS and fE,
ascertaining the resonance frequency fR within a predefined frequency band,
modulating the resonance frequency fR, for example, through sign reversal of the element n2 from the continued fraction code [n0, n1, n2],
demodulating and decoding the changes performed on the transmitter side in the receiver unit.

6. A device for wireless transmission of data or signals, comprising a transmitting unit (1) having a modulator for modulation of information and having a coupler (7) for coupling information into a carrier wave, a receiving unit (E, 2) having a demodulator for demodulation of information and a decoupler (8) for decoupling information from the random processes, in particular for a method according to one of claims 1 through 5, characterized in that the modulator and demodulator are a GS modulator (6) and a GS demodulator (9), respectively.

7. The device according to claim 6, characterized in that the transmitting unit (1) and/or the receiving unit (2) has a noise or random signal generation unit, preferably an electrical or electronic noise signal generation element, such as a noise diode.

8. The device according to claim 6, characterized in that the noise or random signal generation unit or its signals are a component of the modulator and/or the coupler.

9. The device according to claim 6, characterized in that it has a GS sampling unit, so that the noise signal may be sampled at a GS frequency in order to obtain a GS-clocked random process.

10. The device according to claim 9, characterized in that the sampling frequency is a GS node point frequency, preferably a purely n0 frequency.

11. The device according to claim 6, characterized in that it contains a stationary computer or a mobile computer, e.g., a laptop, or a mobile telephone.

12. The device according to claim 6, characterized in that the receiving unit (1) contains a medical, therapeutic, or diagnostic device, preferably a cardiac pacemaker.

13. A modulator and/or demodulator for modulation or demodulation of the information for a device for wireless information transmission, for example, of data or signals, which comprises a transmitting unit having a modulator for the modulation of the information and having a coupler for coupling the information into a random process, a receiving unit having a demodulator for demodulation of the information and a decoupler for decoupling the information from the random process, in particular for a method according to one of claims 1 through 5, characterized in that the modulator or demodulator is a global scaling modulator (6) or global scaling demodulator (9), respectively.

14. The modulator and/or demodulator according to claim 13, characterized in that it is a component or a unit which GS modulates or GS demodulates, respectively, natural noise or random signals, preferably at least one global scaling resonance frequency of two coupled random processes.

15. A use of a noise or random process, noise or random process signal, or component for noise or random signal generation for wireless information transmission of a useful signal using coupled random processes.

16. The use according to claim 15, characterized in that the noise or random process or the noise or random process signal or the component for noise or random signal generation is used for coupling or decoupling into or out of the random processes and/or for modulation or demodulation of the useful signal.

17. The use according to claim 16, characterized in that the noise or random signal of a mobile telephone or a stationary or mobile computer is used.
